(19) United States
(12) Patent Application Publication
(10) Pub. No.: US 2005/0249228 A1
(43) Pub. Date: Nov. 10, 2005

(54) Techniques for providing scalable receive queues

(76) Inventor: Linden Cornett, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/839,923

(22) Filed: May 5, 2004

(51) Int. Cl. H04L 12/28; H04L 12/54; H04L 12/56

(52) U.S. Cl. 370/413; 370/428

(57) ABSTRACT

Briefly, techniques to provide input and output queues. Descriptors may be completed by return descriptors using different queues.

### FIELD

The subject matter disclosed herein generally relates to techniques for utilizing input and output queues.

### DESCRIPTION OF RELATED ART

Receive side scaling (RSS) is a feature in an operating system that allows network adapters that support RSS to direct packets of certain Transmission Control Protocol/Internet Protocol (TCP/IP) flow to be processed on a designated Central Processing Unit (CPU), thus increasing network processing power on computing platforms that have a plurality of processors. The RSS feature scales the received traffic of packets across a plurality of processors in order to avoid limiting the receive bandwidth to the processing capabilities of a single processor.

One implementation of RSS involves using one receive queue for each processor in the system. Accordingly, as the number of processor cores increases so does the number of receive queues. Typically, each receive queue serves as both an “input” and “output” queue, meaning that receive buffers are given to a network interface card on the same queue (and in the same order) that they are returned to the driver of the host system. Receive buffers are used to identify available storage locations in the host system for received traffic. Accordingly, the silicon must provide an on-chip cache for each receive queue. However, adding additional receive queues incurs a significant additional cost and complexity.

If the number of receive queues does not increase with the number of processor cores, the operating system that utilizes RSS attempts to scale across all processor cores in the host system and the RSS implementation requires an extra level of indirection in the driver, which may reduce or eliminate the advantages of RSS. Techniques are needed to support increased numbers of processor cores without the additional cost of adding additional receive queues for each processor core or detriments of not increasing the number of receive queues to match addition of processor cores.

### BRIEF DESCRIPTION OF THE DRAWINGS

FIG. 1 depicts an example computer system that can use embodiments of the present invention.

FIG. 2 depicts an example of elements and entries that can be used by a host system in accordance with an embodiment of the present invention.

FIG. 3 depicts one possible implementation of a network interface controller in accordance with an embodiment of the present invention.

FIG. 4A depicts an example configuration of input and output queues, in accordance with an embodiment of the present invention.

FIG. 4B depicts an example use of input and output queues of the configuration depicted in FIG. 4A, in accordance with an embodiment of the present invention.

FIG. 5 depicts an example array of multiple input queues and array of multiple output queues, in accordance with an embodiment of the present invention.

FIG. 6 depicts a process that may be used by embodiments of the present invention to store ingress packets from a network.

Note that use of the same reference numbers in different figures indicates the same or like elements.

### DETAILED DESCRIPTION

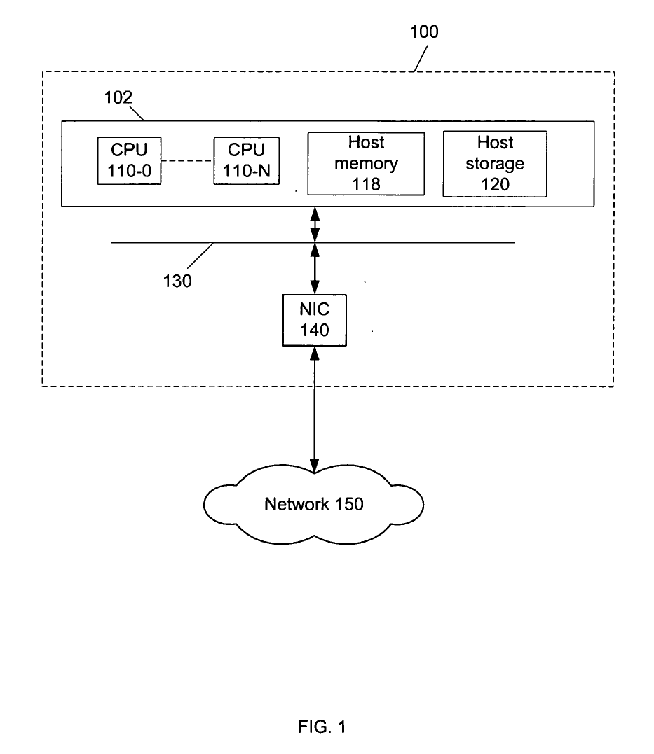

FIG. 1 depicts an example computer system 100 that can use embodiments of the present invention. Computer system 100 may include host system 102, bus 130, and network interface controller (NIC) 140. Host system 102 may include multiple central processing units (CPU 110-0 to CPU 110-N), host memory 118, and host storage 120. Computer system 100 may also include a storage controller to control intercommunication with storage devices (both not depicted) and a video adapter (not depicted) to provide interoperation with video display devices. In accordance with an embodiment of the present invention, computer system 100 may utilize input to output queues in a manner that each descriptor may be completed by a return descriptor using a different queue than that which transferred the descriptor.

CPU 110-0 to CPU 110-N may be implemented as Complex Instruction Set Computer (CISC) or Reduced Instruction Set Computer (RISC) processors or any other processor. Host memory 118 may be implemented as a cache memory such as a RAM, DRAM, or SRAM. Host storage 120 may include a non-volatile memory device (e.g., EEPROM, ROM, PROM, RAM, DRAM, SRAM, flash, firmware, programmable logic, etc.), magnetic disk drive, optical disk drive, tape drive, an internal storage device, an attached storage device, and/or a network accessible storage device. Programs and information in host storage 120 may be loaded into host memory 118 and executed by the one or more CPUs.

Bus 130 may provide intercommunication between host system 102 and NIC 140. Bus 130 may be compatible with Peripheral Component Interconnect (PCI) described for example at Peripheral Component Interconnect (PCI) Local Bus Specification, Revision 2.2, Dec. 18, 1998 available from the PCI Special Interest Group, Portland, Oreg., U.S.A. (as well as revisions thereof); PCI Express; PCI-x described in the PCI-X Specification Rev. 1.0a, Jul. 24, 2000, available from the aforesaid PCI Special Interest Group, Portland, Oreg., U.S.A. (as well as revisions thereof); serial ATA described for example at “Serial ATA: High Speed Serialized AT Attachment,” Revision 1.0, published on Aug. 29, 2001 by the Serial ATA Working Group (as well as related standards); and/or Universal Serial Bus (and related standards).

Computer system 100 may utilize NIC 140 to receive information from network 150 and transfer information to network 150. Network 150 may be any network such as the Internet, an intranet, a local area network (LAN), storage area network (SAN), a wide area network (WAN), or wireless network. Network 150 may exchange traffic with computer system 100 using the Ethernet standard (described in IEEE 802.3 and related standards) or any communications standard.

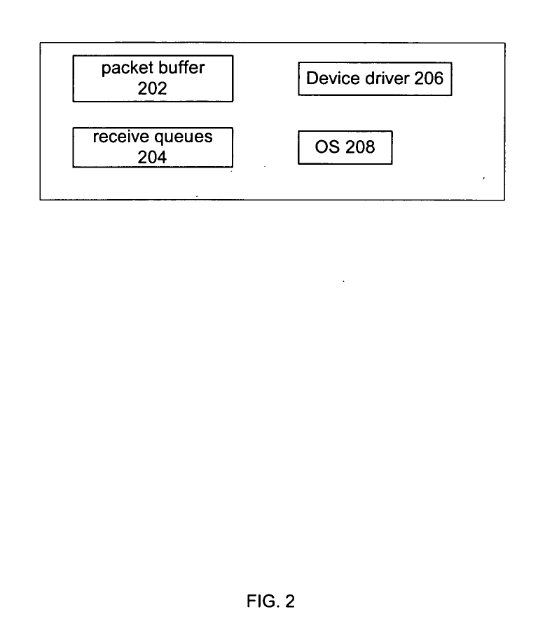

In accordance with an embodiment of the present invention, FIG. 2 depicts an example of elements that can be used by host system 102, although other implementations may be used. For example, host system 102 may use packet buffer 202, receive queues 204, device driver 206, and operating system (OS) 208.

Packet buffer 202 may include multiple buffers and each buffer may store at least one ingress packet received from a network (such as network 150). Packet buffer 202 may store packets received by NIC 140 that are queued for processing by operating system 208.

Receive queues 204 may be data structures that are managed by device driver 206 and used to transfer identities of buffers in packet buffer 202 that store packets. Receive queues 204 may include one or more input queue(s) and multiple output queues. Input queues may be used to transfer descriptors from host system 102 into descriptor storage 308 of NIC 140. A descriptor may describe a location within a buffer and length of the buffer that is available to store an ingress packet. Output queues may be used to transfer return descriptors from NIC 140 to host system 102. A return descriptor may describe the buffer in which a particular ingress packet is stored within packet buffer 202 and identify at least the length of the ingress packet, RSS hash values and packet types, checksum pass/fail, and tagging aspects of the ingress packet such as virtual local area network (VLAN) information and priority information. In one embodiment of the present invention, each input queue may be stored by a physical cache such as host memory 118 whereas contents of the output queue may be stored by host storage 120.

Device driver 206 may be a device driver for NIC 140. Device driver 206 may create descriptors and may manage the use and allocation of descriptors in receive queue 204. Device driver 206 may request that descriptors be transferred to the NIC 140 using an input queue. Device driver 206 may allocate descriptors for transfer using the input queue in any manner and according to any policy. Device driver 206 may signal to NIC 140 that a descriptor is available on the input queue. Device driver 206 may process interrupts from NIC 140 that inform the host system 102 of the storage of an ingress packet into packet buffer 202. Device driver 206 may determine the location of the ingress packet in packet buffer 202 based on a return descriptor that describes such ingress packet and device driver 206 may inform operating system 208 of the availability and location of such stored ingress packet.

In one implementation, OS 208 may be any operating system that supports receive side scaling (RSS) such as Microsoft Windows or UNIX. OS 208 may be executed by each of the CPUs 110-0 to 110-N.

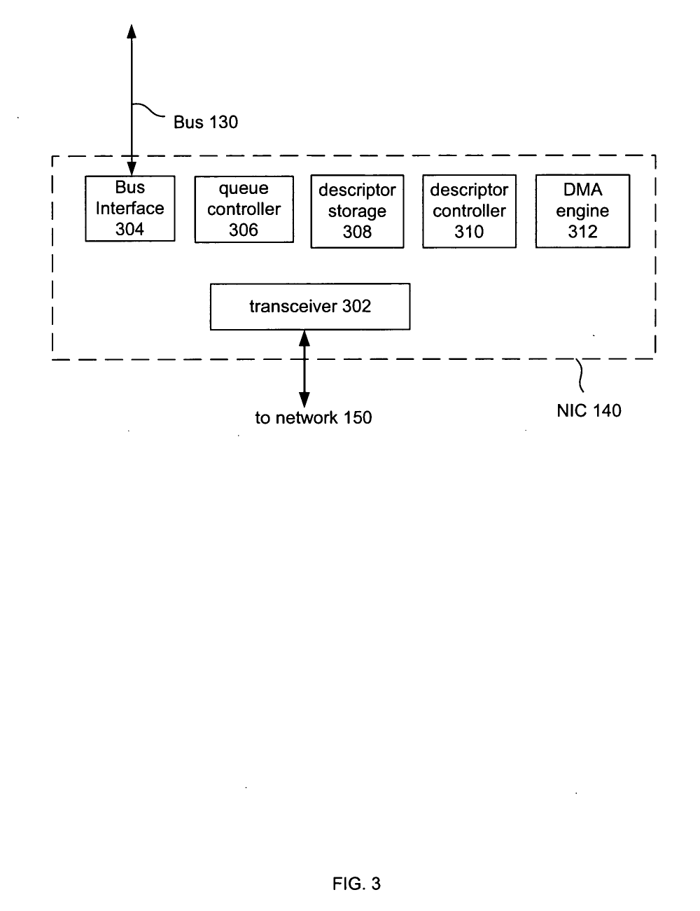

FIG. 3 depicts one possible implementation of NIC 140 in accordance with embodiments of the present invention, although other implementations may be used. For example, one implementation of NIC 140 may include transceiver 302, bus interface 304, queue controller 306, descriptor storage 308, descriptor controller 310, and direct memory access (DMA) engine 312.

Transceiver 302 may include a media access controller (MAC) and a physical layer interface (both not depicted). Transceiver 302 may receive and transmit packets from and to network 150 via a network medium.

Descriptor controller 310 may initiate fetching of descriptors from the input queue of the receive queue. For example, descriptor controller 310 may inform DMA engine 312 to read a descriptor from the input queue of receive queue 206 and store the descriptor into descriptor storage 308. Descriptor storage 308 may store descriptors that describe candidate buffers in packet buffer 208 that can store ingress packets.

Queue controller 306 may determine a buffer of packet buffer 208 to store at least one ingress packet from transceiver 302. In one implementation, based on the descriptors in descriptor storage 208, queue controller 306 creates a return descriptor that describes a buffer into which to write an ingress packet. Return descriptors may be allocated for transfer by output queues in any manner and according to any policy. For example, a next available buffer that meets the criteria needed for the particular ingress packet may be used. In one embodiment, the MAC may return a user-specified value in the return descriptor which could be used to match a receive buffer in the packet buffer to an appropriate management structure that manages access to the packet buffer.

Queue controller 306 may instruct DMA engine 312 to transfer each ingress packet into a receive buffer in packet buffer 202 identified by an associated return descriptor. Queue controller 306 may create an interrupt to inform host system 102 that a packet is stored into packet buffer 202. Queue controller 306 may place the return descriptor in an output queue and provide an interrupt to inform host system 102 that an ingress packet is stored as described by the return descriptor in the output queue.

DMA engine 312 may perform direct memory accesses from and into host storage 120 of host system 102 to retrieve descriptors and to store return descriptors. DMA engine 312 may also perform direct memory accesses to transfer ingress packets into a buffer in packet buffer 202 identified by a return descriptor.

Bus interface 304 may provide intercommunication between NIC 140 and bus 130. Bus interface 304 may be implemented as a USB, PCI, PCI Express, PCI-x, and/or serial ATA compatible interface.

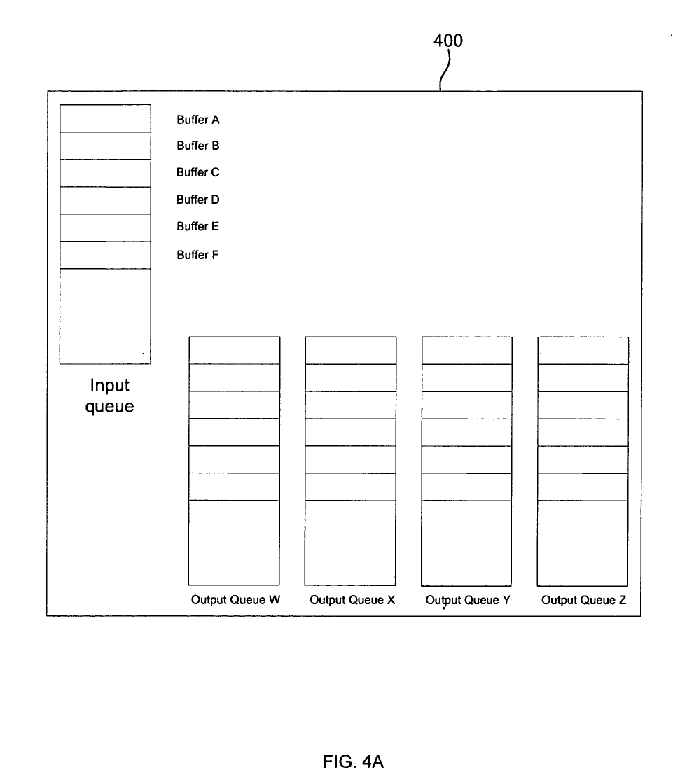

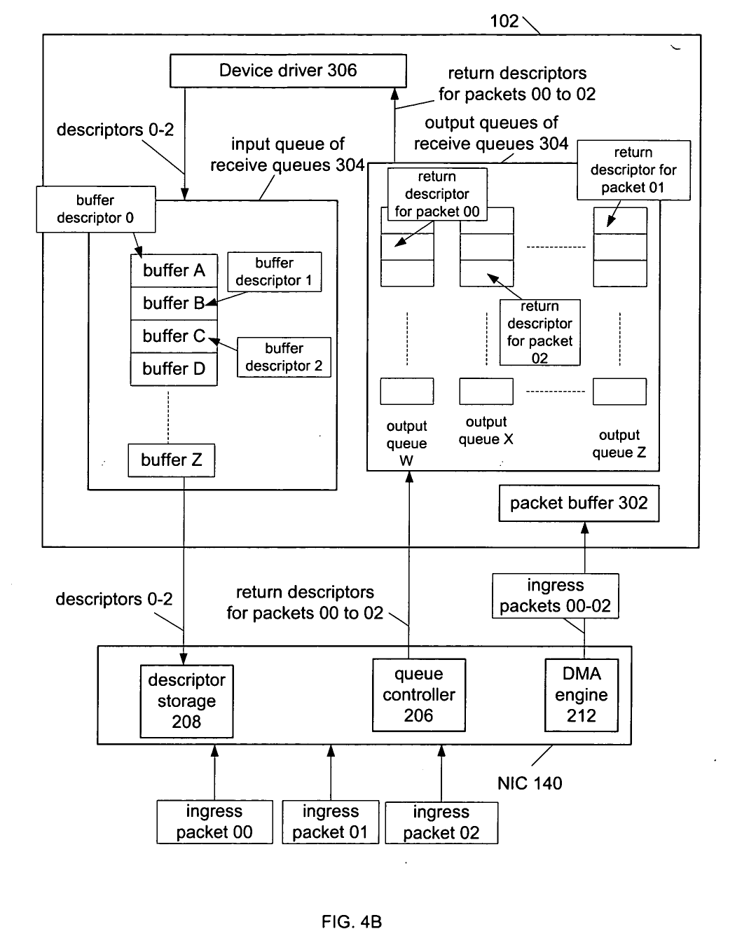

For example, FIG. 4A depicts an example configuration of input and output queues, in accordance with an embodiment of the present invention. In this example, one input queue and multiple output queues W-Z are utilized. In this example, input queue stores descriptors in locations A-F. In this example, return descriptors that complete descriptors transferred using locations A-F in the input queue are allocated among output queues X-Z in locations identified as A-F. However, the descriptors could be allocated among the output queues W-Z in any manner.

FIG. 4B depicts an example use of input and output queues of the configuration depicted in FIG. 4A, in accordance with an embodiment of the present invention. In this example, device driver 306 associated with host system 102 initiates formation of descriptors 0-2 to identify buffers in packet buffer 302 to store ingress packets. An input queue of receive queues 304 transfers descriptors 0-2 to descriptor storage 208 associated with NIC 140. Queue controller 206 provides return descriptors associated with ingress packets 00-02 to device driver 306 using output queues of receive queues 304, where the return descriptors are allocated according to any policy. DMA engine 212 may store ingress packets 00-02 into packet buffer 302 in locations identified by return descriptors 00-02.

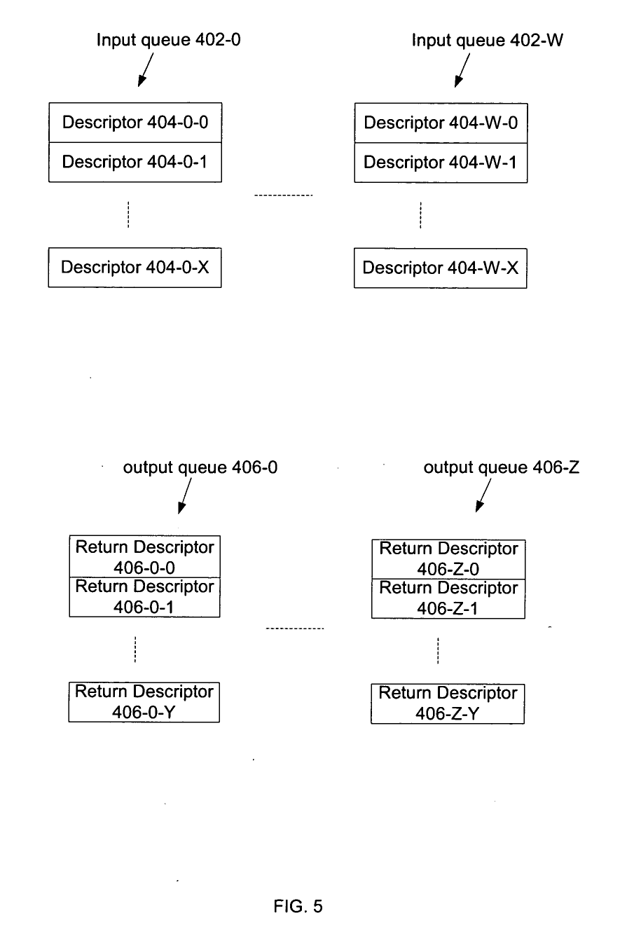

Any number of input and output queues may be used. For example, FIG. 5 depicts another example array of multiple input queues 402-0 to 402-W and array of multiple output queues 406-0 to 406-Z, in accordance with an embodiment of the present invention. Each of the input queues 402-0 to 402-W may be used to transfer buffer descriptors from host system 102 to NIC 140. Input queue 402-0 may transfer buffer descriptors 404-0-0 to 404-O-X. Input queue 402-W may transfer buffer descriptors 404-W-0 to 404-W-X. Output queues 406-0 to 406-Z may be used to transfer return descriptors from NIC 140 to host system 102. Output queue 406-0 may be used to transfer return descriptors 406-0-0 to 406-O-Y. Output queue 406-Z may be used to transfer return descriptors 406-Z-0 to 406-Z-Y.

One embodiment of the present invention provides for input queues dedicated for specific types of traffic (e.g., offload or non-offload). For example, one input queue may transfer descriptors for offload traffic and another input queue may transfer descriptors for non-offload traffic.

One embodiment of the present invention provides for multiple input queues to transfer descriptors that are to be completed by a single output queue. For example, this configuration may be used where the device driver requests NIC 140 to use split headers for some types of traffic and single buffers for other types of traffic. Using this configuration, a first input queue might transfer descriptors for single buffers and second input queue might transfer descriptors for buffers appropriate for split header usage. For split headers usage, a descriptor describes at least two receive buffers in which an ingress packet is stored.

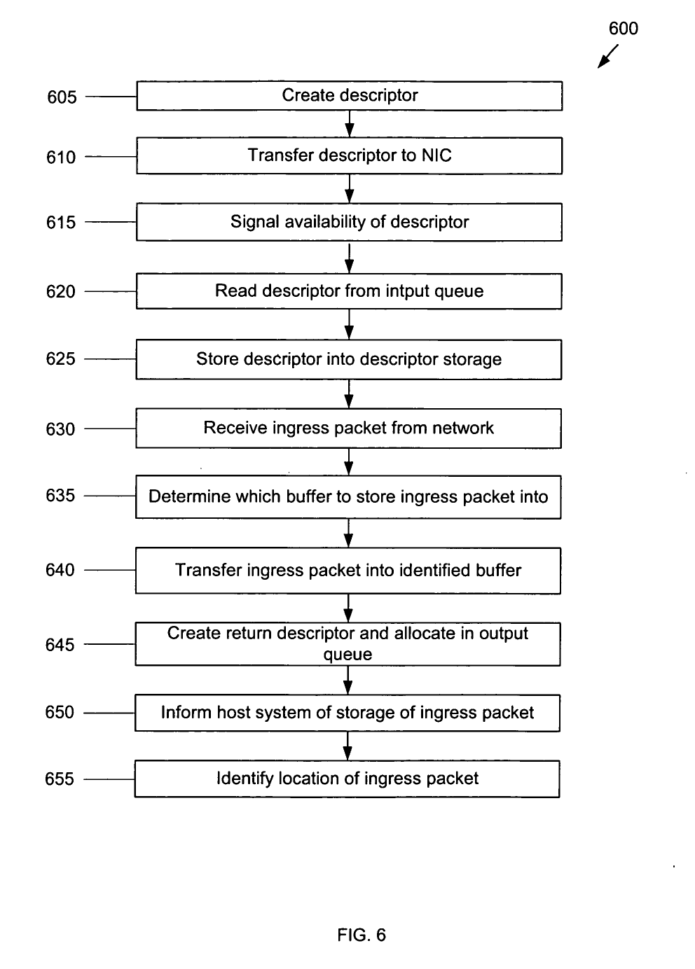

FIG. 6 depicts a process that may be used by embodiments of the present invention to store ingress packets from a network. For example, computer system 100 may use the process of FIG. 6. Actions of the process of FIG. 6 may occur in an order other than the order described herein.

In action 605, the process creates a descriptor of a buffer in a packet buffer that can store an ingress packet. A device driver may create such descriptor. In action 610, the device driver requests that the descriptor be placed on the input queue to transfer the descriptor to a network interface controller (NIC). For example, the input queue may be similar to that described with respect to FIGS. 4A, 4B and 5.

In action 615, the device driver signals to the descriptor controller of the NIC that a descriptor is available on the input queue. In action 620, the descriptor controller instructs a direct memory access (DMA) engine to read the descriptor from the input queue. In action 625, the descriptor controller stores the length and location of the descriptor into a descriptor storage.

In action 630, the NIC receives an ingress packet from a network. In action 635, a queue controller determines which buffer in the packet buffer is to store the ingress packet based on available descriptors stored in the descriptor storage.

In action 640, the queue controller instructs the DMA engine to transfer the received ingress packet identified in action 630 into the buffer determined in action 635. In action 645, the queue controller creates a return descriptor that describes the buffer determined in action 635 and describes the accompanying packet and writes the return descriptor to the appropriate output queue. Return descriptors may be allocated for transfer by output queues in any manner and according to any policy. For example, the output queue may be similar to that described with respect to FIGS. 4A, 4B and 5.

In action 650, the queue controller creates an interrupt to inform the host system that an ingress packet is stored as described by a return descriptor in the output queue. In action 655, the device driver processes the interrupt and determines the location of the ingress packet in the packet buffer based on the return descriptor.

Embodiments of the present invention may be implemented as any or a combination of: hardwired logic, software stored by a memory device and executed by a microprocessor, firmware, an application specific integrated circuit (ASIC), and/or a field programmable gate array (FPGA).

The drawings and the forgoing description gave examples of the present invention. For example, NIC 140 can be modified to support egress traffic processing and transmission from NIC 140 to the network. For example, a DMA engine may be provided to support egress traffic transmission. While a demarcation between operations of elements in examples herein is provided, operations of one element may be performed by one or more other elements. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. An apparatus comprising:
a computational platform capable of interoperating with a network interface controller;
a memory device capable of storing at least one input queue and at least two output queues, wherein each of the at least one input queue transfers descriptors and wherein each of the at least two output queues transfers return descriptors;
at least one microprocessor including capability to:
transfer to the network interface controller a descriptor using at least one input queue, wherein the descriptor identifies a receive buffer to store any ingress packet; and
receive using at least one of the output queues a return descriptor identifying a receive buffer to store an ingress packet, wherein each descriptor is completed by a return descriptor using a different queue than that which transferred the descriptor.

2. The apparatus of claim 1, wherein the memory device is capable of storing the ingress packet into the receive buffer identified by the return descriptor.

3. The apparatus of claim 1, wherein each of the input queues is allocated for a specific type of traffic.

4. The apparatus of claim 1, wherein one input queue is allocated for offload traffic and one input queue is allocated for non-offload traffic.

5. The apparatus of claim 1, wherein multiple input queues transfer descriptors that are to be completed by a single output queue.

6. The apparatus of claim 5, wherein a first input queue of the multiple input queues is allocated for single buffers and wherein a second input queue of the multiple input queues is allocated for split header usage.

7. The apparatus of claim 1, wherein the memory device includes a cache capable of storing input queues.

8. The apparatus of claim 1, wherein the memory device includes a storage device capable of storing output queues.

9. A method comprising:
providing in a descriptor an identifier of a receive buffer to store any ingress packet;
transferring the descriptor using at least one input queue; and
receiving a return descriptor using at least one output queue, wherein the return descriptor identifies a receive buffer in which an ingress packet is stored and wherein each descriptor is completed by a return descriptor using a different queue than that which transferred the descriptor.

10. The method of claim 9, further comprising storing the ingress packet into the receive buffer identified by the return descriptor.

11. The method of claim 9, wherein each input queue is allocated for a specific type of traffic.

12. The method of claim 9, wherein one input queue is allocated for offload traffic and one input queue is allocated for non-offload traffic.

13. The method of claim 9, wherein multiple input queues are allocated to transfer descriptors that are to be completed by a single output queue.

14. The method of claim 13, wherein a first input queue of the multiple input queues is allocated for single buffers and wherein a second input queue of the multiple input queues is allocated for split header usage.

15. A method comprising:
receiving a descriptor using at least one input queue, wherein the descriptor identifies a receive buffer to store any ingress packet;
transferring an ingress packet; and
transferring a return descriptor using at least one output queue, wherein the return descriptor identifies a receive buffer in which the ingress packet is stored and wherein each descriptor is completed by a return descriptor using a different queue than that which transferred the descriptor.

16. The method of claim 15, wherein each input queue is allocated for a specific type of traffic.

17. The method of claim 15, wherein one input queue is allocated for offload traffic and one input queue is allocated for non-offload traffic.

18. The method of claim 15, wherein multiple input queues are allocated to transfer descriptors that are to be completed by a single output queue.

19. The method of claim 18, wherein a first input queue of the multiple input queues is allocated for single buffers and wherein a second input queue of the multiple input queues is allocated for split header usage.

20. An apparatus comprising:
a network interface controller including capability to:
receive a descriptor identifying a receive buffer to store an ingress packet using at least one input queue;
allocate a return descriptor to identify an ingress packet and storage location of the ingress packet; and
transfer the return descriptor using at least one output queue, wherein each descriptor is completed by a return descriptor using a different queue than that which transferred the descriptor.

21. The apparatus of claim 20, wherein the network interface controller is capable of intercommunicating with a host system.

22. The apparatus of claim 21, wherein the network interface controller intercommunicates with the host system using a bus.

23. The apparatus of claim 20, wherein each of the input queues is allocated for a specific type of traffic.

24. The apparatus of claim 20, wherein one input queue is allocated for offload traffic and one input queue is allocated for non-offload traffic.

25. The apparatus of claim 20, wherein multiple input queues transfer descriptors that are to be completed by a single output queue.

26. The apparatus of claim 25, wherein a first input queue of the multiple input queues is allocated for single buffers and wherein a second input queue of the multiple input queues is allocated for split header usage.

27. An article comprising a storage medium, the storage medium comprising machine readable instructions stored thereon that when executed by a machine cause the machine to:
provide in a descriptor an identifier of a receive buffer to store any ingress packet;
transfer the descriptor using at least one input queue; and
receive a return descriptor using at least one output queue, wherein the return descriptor identifies a receive buffer in which an ingress packet is stored and wherein each descriptor is completed by a return descriptor using a different queue than that which transferred the descriptor.

28. The article of claim 27, wherein each of the input queues is allocated for a specific type of traffic.

29. The article of claim 27, wherein one input queue is allocated for offload traffic and one input queue is allocated for non-offload traffic.

30. The article of claim 27, wherein multiple input queues transfer descriptors that are to be completed by a single output queue.

31. The article of claim 30, wherein a first input queue of the multiple input queues is allocated for single buffers and wherein a second input queue of the multiple input queues is allocated for split header usage.

32. An article comprising a storage medium, the storage medium comprising machine readable instructions stored thereon that when executed by a machine cause the machine to:
receive a descriptor using at least one input queue, wherein the descriptor identifies a receive buffer to store any ingress packet;
transfer an ingress packet; and
transfer a return descriptor using at least one output queue, wherein the return descriptor identifies a receive buffer in which the ingress packet is stored and wherein each descriptor is completed by a return descriptor using a different queue than that which transferred the descriptor.

33. The article of claim 32, wherein each of the input queues is allocated for a specific type of traffic.

34. The article of claim 32, wherein one input queue is allocated for offload traffic and one input queue is allocated for non-offload traffic.

35. The article of claim 32, wherein multiple input queues transfer descriptors that are to be completed by a single output queue.

36. The article of claim 35, wherein a first input queue of the multiple input queues is allocated for single buffers and wherein a second input queue of the multiple input queues is allocated for split header usage.

37. A system comprising:
a computational platform capable of interoperating with a network interface controller;
a bus;
a memory device capable of storing at least one input queue and at least two output queues, wherein each of the at least one input queue transfers descriptors and wherein each of the at least two output queues transfers return descriptors; and
at least one microprocessor includes capability to:
transfer a descriptor using by at least one input queue to the network device; and
receive a return descriptor identifying storage of an ingress packet using at least one of the output queues, wherein each descriptor is completed by a return descriptor using a different queue than that which transferred the descriptor.

38. The system of claim 37, wherein the bus is compatible with PCI

39. The system of claim 37, wherein the bus is compatible with PCI Express.

40. The system of claim 37, wherein the bus is compatible with USB.

41. The system of claim 37, further comprising a video adapter interoperable with the bus.

42. The system of claim 37, further comprising a storage controller interoperable with the bus.
